(19) United States
(12) Patent Application Publication
(10) Pub. No.: US 2026/0346474 A1
(43) Pub. Date: Nov. 5, 2026

(54) COMPLIANT FASTENING SUBSYSTEM FOR USE WITH A ROBOTIC MANIPULATOR

(71) Applicant: ROBOFORCE INC., Milpitas, CA (US)

(72) Inventors: Dan ZHAO, San Jose, CA (US); Yunfei GUO, Sunnyvale, CA (US); Xizhi YANG, Sunnyvale, CA (US); Pengcheng ZHAO, San Jose, CA (US); Changkai ZHOU, Mountain View, CA (US); Biao MA, Sunnyvale, CA (US)

(73) Assignee: ROBOFORCE INC., Milpitas, CA (US)

(21) Appl. No.: 19/735,181

(22) Filed: Jul. 8, 2026

Related U.S. Application Data
(62) Division of application No. 19/467,759, filed on Feb. 2, 2026.
(60) Provisional application No. 63/752,220, filed on Jan. 31, 2025.

(51) Int. Cl. B25J 15/00

(52) U.S. Cl. CPC B25J 15/0019; B25J 15/0004

(57) ABSTRACT

A compliant fastening subsystem for use with a robotic manipulator includes a fastener engagement interface, a power transmission element, and a compliance mechanism. The fastener engagement interface is configured to engage a screw, nut, or bolt. The power transmission element is configured to provide rotational motion to the fastener engagement interface. The compliance mechanism is operatively coupled between the power transmission element and the robotic manipulator. The compliance mechanism provides controlled compliance along a selected axis while remaining substantially rigid along one or more other axes to enable controlled application of torque to the fastener engagement interface.

### CROSS-REFERENCE TO RELATED APPLICATIONS

This patent application is a divisional of United States Patent Application No. 19/467,759, filed Feb. 2, 2026, which claims the benefit of and priority to United States Provisional Patent Application No. 63/752,220, filed Jan. 31, 2025. The content of the 19/467,759 and 63/752,220 applications is incorporated herein by reference in its entirety for all purposes.

### FIELD

The embodiments discussed herein are related to a compliant fastening subsystem for use with a robotic manipulator.

### BACKGROUND

The subject matter claimed herein is not limited to embodiments that solve any disadvantages or that operate only in environments such as those described above. Rather, this background is only provided to illustrate one example technology area where some embodiments described herein may be practiced.

Mechanical fastening is one of the fundamental operations in assembly processes across a wide range of industries, including manufacturing, fabrication, construction, aerospace, shipbuilding, and infrastructure installation. A substantial portion of mechanical fastening operations rely on rotational motion to drive screws, bolts, and nuts into corresponding threaded counterparts. There exist thousands of different screw–nut and bolt–nut combinations, varying in size, geometry, material, torque requirement, and installation environment.

Prior to approximately the mid-20th century, the majority of screw driving operations were performed manually using hand-operated screwdrivers, where all rotational motion and applied force were generated directly by human effort. Beginning around the 1950s and 1960s, electrically powered screwdrivers became increasingly common and were widely adopted in manufacturing, construction, and maintenance applications due to improved efficiency, repeatability, and reduced operator fatigue.

By the late 1980ss and 1990s, powered screwdrivers began to be integrated into industrial robotic arms and automated production lines to further increase throughput and consistency. These automated fastening systems are typically deployed in highly structured environments, where parts are precisely fixtured and transported to fixed screw-driving stations. High positional accuracy is achieved by controlling the workspace geometry rather than by adapting the tool or robot to environmental variability.

While such systems have proven effective in high-volume, low-variation manufacturing, they exhibit several limitations. First, the fastening process is generally constrained to a fixed location, requiring large or heavy workpieces to be transported to the fastening station. Second, many robotic screw-driving systems are optimized for relatively low-torque applications, often below approximately 10 Nm. For fastening tasks requiring higher torque, the corresponding power tools tend to be heavy and bulky, necessitating large stationary fixtures, counterbalance systems, or dedicated machinery to support the tool weight and reaction forces.

As a result, existing automated screw-driving solutions are poorly suited for fastening tasks distributed across large structures or wide workspaces, such as those encountered in construction, shipbuilding, outdoor assembly, or overhead installation scenarios. In these environments, mobility, reach, and adaptability are critical, yet conventional systems lack sufficient flexibility while maintaining high torque capability and precision.

To address alignment challenges, some prior approaches have introduced compliant connectors between robotic arms and screw-driving tools. These compliance mechanisms typically allow passive motion in multiple translational and rotational directions. While such universal compliance may assist in initial alignment, it introduces additional challenges for high-precision fastening. In particular, unrestricted compliance can degrade positional and angular accuracy, making it difficult to reliably align screws, bolts, or nuts with their mating threads. Consequently, such systems could affect force/torque sensors and block sensing algorithms to detect successful alignment, increasing system complexity and cost.

Furthermore, for fastening operations requiring both high torque and precise control over rotational angle or final tightening state, broadly compliant mechanisms may reduce accurate control of fastening depth, preload, or final torque. As a result, existing compliant tool interfaces may be unsuitable for applications demanding both high mechanical performance and precise fastening outcomes.

In addition, many existing automated fastening systems deployed in factory automation lines or robotic arm applications are configured to operate on only one side of a fastening interface. Such systems typically engage either a screw or a nut from a single accessible surface, or drive a fastener into a pre-threaded or blind hole without actively stabilizing a corresponding component on the opposite side. While this approach is suitable for certain applications, a substantial number of real-world fastening tasks require coordinated operation on both sides of a fastening surface. For example, in many assemblies a bolt must be held or restrained on one side while a nut is driven or tightened on the opposite side. Conventional robotic fastening systems often lack an integrated mechanism for performing such dual-side operations, relying instead on manual intervention, custom fixtures, or separate tooling. These approaches reduce automation efficiency and limit applicability in environments where access is constrained or where the fastening location varies.

Accordingly, there exists a need for improved screw and nut driving systems that overcome the limitations of existing powered and robotic fastening tools, particularly in the context of mobile robotic platforms and challenging, unstructured environments.

### SUMMARY

The present disclosure relates to a compliant screw and nut driving end effector system configured for integration with robotic manipulators, including mobile robotic arms, to perform fastening operations in a wide range of industrial environments. In one embodiment, the system comprises a driving subsystem configured to apply rotational motion and torque to a fastener, a holding subsystem configured to stabilize a corresponding fastener component on an opposite side of a fastening surface, and one or more compliance mechanisms operatively coupled to the driving subsystem, the holding subsystem, or both.

In some embodiments, the driving subsystem comprises an electrically powered driving mechanism configured to engage screws, bolts, or nuts of varying types, sizes, and geometries using interchangeable tool interfaces. The driving subsystem may be configured to deliver controlled rotational motion, torque, speed, or angular displacement based on preprogrammed parameters, sensor feedback, or a combination thereof. In certain embodiments, the driving subsystem is configured for operation in confined or hard-to-reach spaces.

In some embodiments, the holding subsystem is configured to engage, restrain, or stabilize a bolt, nut, or other fastener component positioned on an opposite side of a fastening surface relative to a driven fastener. The holding subsystem may be compactly arranged to access restricted spaces and may be configured to accommodate positional variation, surface irregularities, or alignment uncertainty during fastening operations.

In some embodiments, the system includes one or more compliance mechanisms that provide controlled relative motion or force accommodation between the end effector and the fastener, between subsystems of the end effector, or between the end effector and a robotic manipulator. The compliance mechanisms may be mechanical, electromechanical, software-defined, or combinations thereof. Such compliance may be configured to selectively accommodate misalignment, reduce mechanical stress, improve engagement accuracy, or enable advanced control strategies, including force control, torque control, impedance control, admittance control, or hybrid control approaches.

In certain embodiments, the driving subsystem and the holding subsystem are configured to operate cooperatively to perform dual-side fastening operations, in which one fastener component is stabilized while a corresponding component is driven into engagement. In other embodiments, the driving subsystem and the holding subsystem are independently operable and may be used separately for single-sided fastening, part localization, torque reaction management, or other fastening-related tasks.

In some embodiments, the end effector system is configured for integration with a robotic platform, including fixed-base robotic arms and mobile robotic platforms, enabling autonomous or semi-autonomous fastening operations across distributed workspaces. The system may be used in assembly lines, maintenance operations, construction environments, or other applications requiring precise, adaptable, and repeatable fastening performance.

The object and advantages of the disclosed embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a perspective view of an example screw-driving subsystem including a motor-driven fastener engagement interface, an adjustable extension structure, a compliant mechanism, and a connection interface for coupling to a robotic manipulator.

FIG. 2 is a perspective view of an example bolt-holding subsystem including a bolt-holding tip assembly, an adjustable extension structure, a linear compliance mechanism, and a connection interface configured to couple to a robotic manipulator.

FIG. 3 is a perspective view of a bolt-holding subsystem including a bolt-holding tip assembly, an adjustable extension structure, a power motor, and a compliant structure configured to provide rotational compliance between a connection interface and a fastener engagement interface.

FIG. 4 is a perspective view illustrating an example robotic embodiment in which a screw-driving subsystem and a holding subsystem are respectively mounted on robotic arms and positioned for a dual-side fastening operation.

### DETAILED DESCRIPTION

The present disclosure relates to advancements in robotic fastening end effector systems, specifically addressing limitations of existing automated screw and nut driving tools in terms of alignment flexibility, torque precision, and adaptability to constrained or unstructured environments. Conventional robotic fastening solutions often suffer from sensitivity to positional and angular misalignment between fastener components, leading to engagement failures, increased mechanical strain, and inconsistent torque application. The disclosed system introduces one or more compliance mechanisms integrated within the driving and/or holding subsystems, which accommodate axial and angular misalignments while maintaining robust torque transmission, thereby enhancing fastening reliability without sacrificing precision.

Unlike traditional approaches that employ broadly compliant connectors yielding multi-axis compliance that can diminish control accuracy, the current disclosure provides selectively guided compliance structures that retain rigidity in directions orthogonal to the compliant axis. This selective compliance ensures precise control of rotational motion and torque application while mitigating off-axis loading on robotic components. Furthermore, the disclosed end effector system supports interchangeable fastener engagement interfaces and adjustable extension structures, enabling operation in restricted, obstructed, or variable workspace geometries unattainable by conventional rigid tools.

The end effector system further advances robotic fastening capabilities by enabling coordinated dual-side fastening operations via cooperating driving and holding subsystems mounted on one or multiple robotic manipulators. This configuration facilitates controlled stabilization and torque reaction management on opposite sides of a fastening surface, expanding applicability to complex assembly scenarios often requiring synchronized dual-tool operation. Optional sensor integration and advanced control strategies, including software-defined virtual compliance, impedance control, and model-based state estimation, provide enhanced feedback and adaptability during fastening tasks.

The disclosed system delivers significant improvements over existing robotic fastening technologies by combining mechanical compliance tailored for controlled misalignment accommodation, modular adjustability for diverse fastener types and constrained environments, and flexible operation modes supporting both single-sided and dual-sided fastening. These innovations enable higher precision, increased torque capacity, improved robustness to environmental variability, and greater automation efficiency in a wide array of industrial applications.

Compared to conventional powered screwdrivers and robotic fastening tools, embodiments of the present disclosure provide several technical improvements. In some embodiments, the end effector system offers enhanced flexibility, allowing operation across a variety of installation configurations, workspace geometries, and fastening orientations. This flexibility enables fastening tasks to be performed on large structures, distributed locations, or in environments where fixed tooling is impractical.

In addition, embodiments of the present disclosure provide high precision and high torque density while maintaining a relatively low tool weight. This allows robotic manipulators, including mobile robotic platforms, to perform fastening operations that would otherwise require large stationary equipment or manual intervention. The disclosed compliance mechanisms further improve alignment accuracy and reduce mechanical stress during fastening, enabling reliable operation without excessive sensing or rigid fixturing.

The embodiments described herein are not limited to the specific configurations illustrated or described, and various modifications, substitutions, and combinations may be made without departing from the scope of the present disclosure.

Embodiments of the present disclosure will be explained with reference to the accompanying drawings.

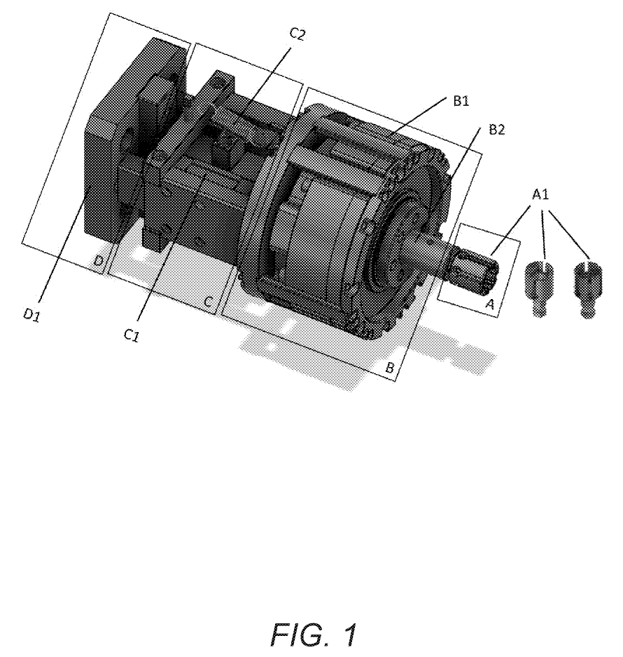

FIG. 1 is a perspective view of a screw-driving subsystem of a compliant screw and nut driving end effector system, in which a tool-side fastener engagement portion is coupled through a compliance portion to a robot-side mounting portion to support controlled torque application while accommodating misalignment during engagement, in accordance with at least one embodiment of the present disclosure. The screw-driving subsystem includes a fastener engagement interface arranged as tip assembly A carrying interchangeable screw driver tips A1, an actuation and transmission portion arranged as adjustable extension structure B including power motor B1 and adjustable extension B2, a compliance portion arranged as compliant structure and mechanism C including linear sliding rails C1 and spring C2 (combined to form spring-loaded slider), and a robot-side coupling portion arranged as connection interface D including mounting interface plate D1. Additionally, the screw-driving subsystem may be mounted to a robotic manipulator directly at connection interface D or via an intermediate adapter, tool changer, or wrist interface, and the arrangement of components A, B, C, and D may be selected to address available workspace, approach direction to a fastener, and permissible reaction loads applied to the robotic manipulator during a fastening operation.

In some embodiments, tip assembly A is positioned at a distal end of the screw-driving subsystem and defines the tool interface that engages the targeted fastener component. Interchangeable screw driver tips A1 are configured to be selectively installed on tip assembly A to match different fastener drive geometries and sizes, including by exchanging one tip for another during tool changeover. Additionally, tip assembly A may include an interface that transmits rotational motion from adjustable extension structure B to the installed one of interchangeable screw driver tips A1, and the interface may include a keyed coupling, a splined coupling, a hex coupling, a quick-release coupling, or a collet-type coupling. Furthermore, tip assembly A may include a retention feature configured to retain a tip A1 against axial separation during torque application, and the retention feature may include a detent, a spring-biased ball, a latch, or a threaded retention element. In some embodiments, tip assembly A and interchangeable screw driver tips A1 are configured to engage a screw head, a bolt head, a nut, or another torque-receiving feature, and tip assembly A may be configured to accommodate a fastener engagement axis aligned with a rotation axis of adjustable extension structure B.

In some embodiments, adjustable extension structure B provides the driven rotation for tip assembly A and also provides reach and packaging flexibility for accessing fasteners in restricted or obstructed spaces. Power motor B1 is coupled to adjustable extension structure B and is configured to generate controlled rotational motion for driving a fastener engaged by tip assembly A, including controlled rotational speed, torque, and angular position. Additionally, power motor B1 may include an encoder, a resolver, a Hall sensor set, or another rotation sensing element to provide feedback indicative of angular position, angular velocity, or commutation state, and power motor B1 may be controlled based on feedback from a current sensor, a torque sensor, a force sensor, or a vision system. Adjustable extension B2 extends between power motor B1 and tip assembly A to transmit the rotational motion to tip assembly A, and adjustable extension B2 is configured with an adjustable length to position tip assembly A at a selected offset from power motor B1. Furthermore, adjustable extension B2 may include one or more shafts, couplers, or gear elements arranged to transmit torque from power motor B1 to tip assembly A along the fastener engagement axis, and such elements may include a coaxial shaft, a telescoping shaft, a universal-joint coupling, a belt drive, a chain drive, a planetary gear stage, a bevel gear stage, or a harmonic drive. In one aspect, adjustable extension structure B includes structural members configured to transfer reaction loads between tip assembly A and compliant structure and mechanism C during torque application, and adjustable extension structure B may include a housing that encloses one or more transmission elements and that provides a mounting interface for auxiliary components.

In some embodiments, the compliance mechanism is disposed within the rotational drivetrain of the screw-driving subsystem such that the compliance mechanism is positioned between power motor B1 and tip assembly A (i.e., between the actuation source and the fastener engagement interface). In this configuration, rotational motion generated by power motor B1 is transmitted through a compliant coupling or compliant transmission stage before reaching the interface that directly engages the fastener, thereby allowing the fastener engagement interface to self-align or accommodate axial and/or angular misalignment while maintaining controlled delivery of torque, speed, and/or angular position. By locating compliance between power motor B1 and tip assembly A, the subsystem may reduce cam-out, reduce off-axis loading on the tip, and improve seating reliability when approach alignment is imperfect.

Non-limiting examples of compliance mechanisms positioned between power motor B1 and tip assembly A include: (i) a torsionally compliant coupling configured to transmit torque while permitting limited angular deflection (e.g., a spring-coupled jaw coupling, elastomeric spider coupling, or beam coupling), (ii) an axial compliance element disposed in series with adjustable extension B2 (e.g., a spring-biased telescoping shaft or splined slip member defining an allowable axial travel), (iii) a flexure-based coupling that provides controlled compliance about one or more axes while remaining substantially rigid about other axes, and (iv) a magnetic or friction-limited coupling configured to protect against overload while preserving commanded torque profiles. In some embodiments, a travel limiter, end stop, or preload adjustment feature sets a compliance range and a compliance value for the between-motor-and-interface compliance mechanism.

According to an embodiment, compliant structure and mechanism C is disposed between adjustable extension structure B and connection interface D to provide controlled compliance during approach and engagement of interchangeable screw driver tips A1 with a fastener. Linear sliding rails C1 define a guided translation path along a selected compliance axis aligned with the fastener engagement axis, and spring C2 biases relative motion along the guided translation path to provide a compliant response to axial contact forces during engagement. Additionally, the combination of linear sliding rails C1 and spring C2 permits relative axial displacement between the robot-side portion and the tool-side portion within an allowable travel range, supporting accommodation of positional error during alignment while enabling torque transfer through the drivetrain to tip assembly A. Furthermore, compliant structure and mechanism C is configured to limit motion along one or more directions transverse to the selected compliance axis via the guided constraint of linear sliding rails C1, thereby supporting controlled application of rotational torque by power motor B1 while the axial compliance assists seating of interchangeable screw driver tips A1 into a fastener receptacle. In some embodiments, spring C2 includes a coil spring, a torsion spring coupled through a linkage, a wave spring stack, a Belleville washer stack, an elastomer element, or a gas spring, and the bias force may be set by a preload adjustment feature. Additionally, linear sliding rails C1 may be implemented as profiled rails with rolling elements, as sliding bushings on guide rods, as a dovetail slide, or as another guided member configured to constrain relative translation. Furthermore, compliant structure and mechanism C may include a hard stop or a travel limiter configured to set a maximum compression displacement, and the travel limiter may be selected to maintain engagement force within a defined range for a given application. In some embodiments, compliant structure and mechanism C provides compliance along a single axis, and in other embodiments compliant structure and mechanism C is replaced or supplemented with a rotational compliance element, a flexure element, a magnetic coupling, or an actively controlled compliance implemented via a controller commanding the robotic manipulator and/or power motor B1.

In some instances, connection interface D provides a mechanical coupling between the screw-driving subsystem and a robotic manipulator or tool mounting system. Mounting interface plate D1 forms a structural attachment feature of connection interface D and is configured for direct or indirect mounting to an end-of-arm interface of the robotic manipulator, including via a bolt pattern, adapter plate, or tool changer interface. Additionally, connection interface D may include one or more alignment features configured to register the screw-driving subsystem to the robotic manipulator, and the alignment features may include pins, bushings, dowels, or keyed surfaces. Additionally, connection interface D may include one or more passages, conduits, or interfaces for routing electrical power, control signals, or sensor signals to power motor B1 or to other components coupled to adjustable extension structure B, and such routing may be provided through mounting interface plate D1. Additionally, connection interface D is arranged to react operational loads transferred through compliant structure and mechanism C, including reaction forces associated with driving torque transmitted from power motor B1 through adjustable extension B2 to tip assembly A. Furthermore, the arrangement of connection interface D, compliant structure and mechanism C, adjustable extension structure B, and tip assembly A supports an operational sequence in which the robot positions the fastener engagement interface toward a target fastener, compliant structure and mechanism C accommodates residual axial misalignment during engagement, and power motor B1 applies controlled rotational motion through adjustable extension B2 to the installed one of interchangeable screw driver tips A1 to perform a fastening operation. In some embodiments, the screw-driving subsystem is configured to operate under torque control, speed control, angular position control, or a combined torque-angle profile based on a selected fastening strategy, and feedback from power motor B1 and/or external sensors may be used to detect engagement state, detect cam-out, or determine an end-of-tightening condition.

Modifications, additions, or omissions may be made to the subsystems of FIG. 1 without departing from the scope of the present disclosure. For example, in some embodiments, the subsystems may include any number of other components that may not be explicitly illustrated or described.

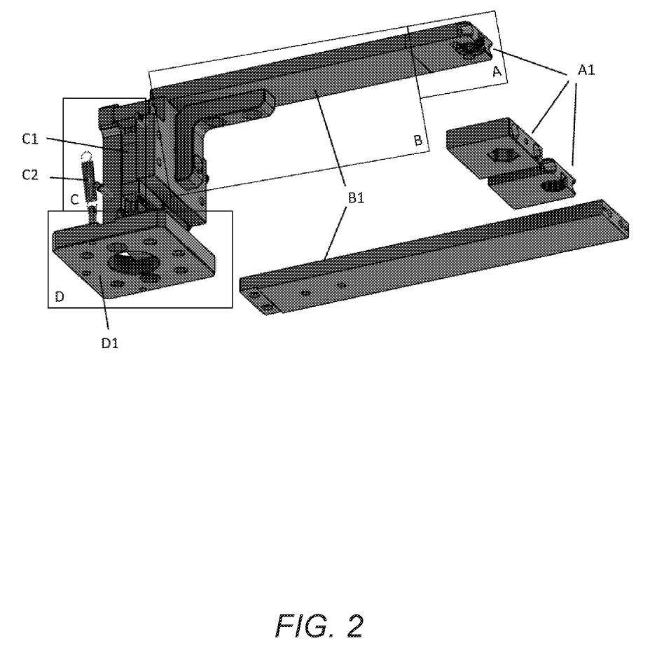

FIG. 2 is a perspective view of a holding subsystem configured to engage and stabilize a fastener component positioned on an opposite side of a fastening surface relative to a driven fastener component, while accommodating alignment variation through a linear compliance mechanism, in accordance with at least one embodiment of the present disclosure. The holding subsystem includes bolt-holding tip assembly A carrying one or more interchangeable tips A1, an adjustable extension structure B arranged to provide reach and torque reaction capability, a compliant structure and mechanism C arranged to provide guided axial compliance via linear sliding rails C1 and spring C2, and a connection interface D including mounting interface plate D1 configured to couple the holding subsystem to a robotic manipulator or tool mounting system. Additionally, the holding subsystem may be used in a dual-side fastening operation in coordination with a separate driving subsystem, and the holding subsystem may also be used in a single-side operation to stabilize a fastener component or to apply rotation to a fastener component when a corresponding tool is not present on the opposite side of the fastening surface.

In one aspect, bolt-holding tip assembly A is disposed at a distal end of adjustable extension structure B and defines a tool-side fastener engagement interface that engages a bolt head, nut, or other fastener component for restraint during a fastening operation. Interchangeable tips A1 are configured to be selectively installed on bolt-holding tip assembly A to match different fastener geometries and sizes, including by exchanging one of interchangeable tips A1 for another during tool changeover or during reconfiguration for a different fastening task. Additionally, bolt-holding tip assembly A may include a retention element configured to retain the installed one of interchangeable tips A1 against separation during engagement, and the retention element may include a detent, a latch, a threaded fastener, or a magnet. Furthermore, bolt-holding tip assembly A may be configured as a socket interface, an open-end interface, a box-end interface, a multi-point interface, or a keyed interface, and bolt-holding tip assembly A may include a compliance-tolerant lead-in geometry configured to guide seating onto a fastener component. Additionally, bolt-holding tip assembly A and the installed one of interchangeable tips A1 define a reaction interface that transfers holding loads into adjustable extension structure B when an opposite-side driving tool applies torque to a mating fastener component.

In some embodiments, adjustable extension structure B provides a structural offset that enables access to fastener components located in restricted or obstructed spaces while supporting torque-reaction loading during dual-side fastening operations. Adjustable extension structure B may include a body and bracket features arranged to position bolt-holding tip assembly A at a selected standoff relative to connection interface D, and adjustable extension structure B may be configured with a selectable length to tune reach and leverage. Additionally, adjustable extension structure B is arranged to function as a lever arm that transfers reaction torque from bolt-holding tip assembly A toward the robot-side portion of the holding subsystem, including when the engaged fastener component is restrained against rotation while a corresponding fastener component is driven on an opposite side of a fastening surface. Furthermore, adjustable extension structure B may include a rigid member, a telescoping member, an articulated member with one or more joints, or a foldable member, and the structural configuration may be selected based on clearance constraints near the fastener. Furthermore, FIG. 2 illustrates a power motor B1 coupled to adjustable extension structure B, and power motor B1 may be operated to induce rotation of bolt-holding tip assembly A for tasks in which the holding tool also turns a fastener component, or power motor B1 may remain inactive during tasks in which bolt-holding tip assembly A restrains rotation while reaction torque is transmitted through adjustable extension structure B. In some embodiments, power motor B1 is coupled to bolt-holding tip assembly A through a transmission element integrated into adjustable extension structure B, and the transmission element may include a shaft, a gear set, or a belt drive.

In some embodiments, compliant structure and mechanism C is disposed between adjustable extension structure B and connection interface D to accommodate alignment variation during approach and engagement of bolt-holding tip assembly A with a target fastener component. Linear sliding rails C1 define a guided translation path along a selected compliance axis oriented along a fastener engagement direction, and spring C2 biases relative motion along the guided translation path to provide a compliant response to contact forces arising during seating of the installed one of interchangeable tips A1 on the target fastener component. Additionally, the combination of linear sliding rails C1 and spring C2 permits relative axial displacement between the robot-side portion and the tool-side portion within an allowable travel range, supporting engagement in the presence of positional error while maintaining guided alignment of bolt-holding tip assembly A. Furthermore, the guided constraint of linear sliding rails C1 limits relative motion along one or more directions transverse to the selected compliance axis so that adjustable extension structure B can transfer holding loads and reaction torque through compliant structure and mechanism C without introducing uncontrolled lateral displacement during the fastening operation. In some embodiments, compliant structure and mechanism C includes a friction-reduction interface along the guided translation path, and the friction-reduction interface may include rolling elements, bushings, or surface treatments configured to support guided motion under torque-reaction loading.

In one aspect, connection interface D provides a robot-side coupling for mounting the holding subsystem to a robotic manipulator, including a mobile robotic arm, a fixed-base robotic arm, or a tool changer. Mounting interface plate D1 forms a structural attachment feature of connection interface D and is configured to couple to an end-of-arm interface via a bolt pattern, adapter, or mating tool mount. Additionally, connection interface D may include one or more alignment features and one or more load paths configured to transfer reaction torque from adjustable extension structure B into the robotic manipulator through mounting interface plate D1. Furthermore, connection interface D is arranged to react operational loads transmitted from adjustable extension structure B through compliant structure and mechanism C, including axial forces associated with engagement and reaction forces associated with torque applied to, or resisted by, bolt-holding tip assembly A. Furthermore, the arrangement of connection interface D, compliant structure and mechanism C, adjustable extension structure B, and bolt-holding tip assembly A supports an operational sequence in which a robotic manipulator positions bolt-holding tip assembly A toward a target fastener component, compliant structure and mechanism C accommodates residual axial misalignment as the installed one of interchangeable tips A1 seats on the fastener component, and adjustable extension structure B provides a torque-reaction path while the fastener component is restrained or rotated in coordination with a driving subsystem on an opposite side of the fastening surface. In some embodiments, the holding subsystem includes a sensor interface at connection interface D, within compliant structure and mechanism C, or near bolt-holding tip assembly A, and the sensor interface is used to provide feedback indicative of contact force, reaction torque, position, or engagement state.

Modifications, additions, or omissions may be made to the subsystems of FIG. 2 without departing from the scope of the present disclosure. For example, in some embodiments, the subsystems may include any number of other components that may not be explicitly illustrated or described.

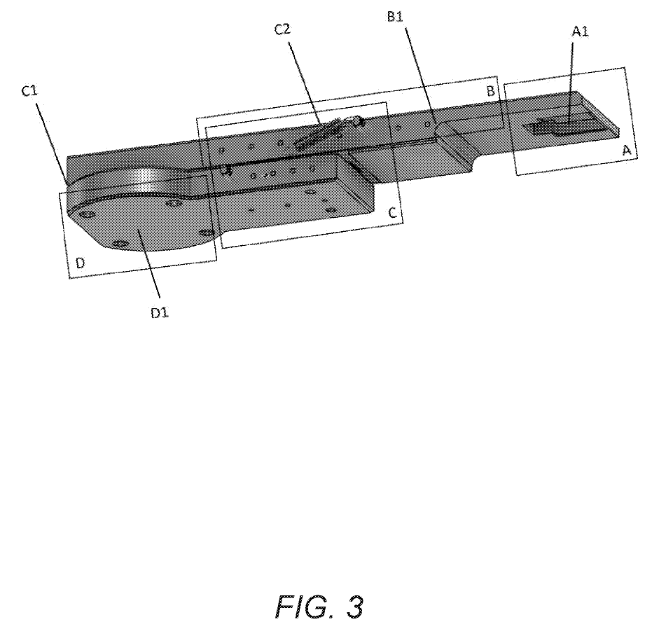

FIG. 3 is a perspective view of a bolt-holding subsystem configured for use in a dual-side fastening operation, in which bolt-holding tip assembly A engages a first fastener component to restrain rotation while a driving tool on the opposite side applies torque to a corresponding fastener component, in accordance with at least one embodiment of the present disclosure. The bolt-holding subsystem includes bolt-holding tip assembly A carrying one or more interchangeable screw driver tips A1, an adjustable extension structure B coupled between bolt-holding tip assembly A and a robot-side mounting portion, a power motor B1 coupled to adjustable extension structure B, a compliant structure and mechanism C arranged to provide rotational compliance between a tool-side portion and a robot-side portion, and a connection interface D including a mounting interface plate D1 configured to couple to a robotic manipulator or tool mounting system. Additionally, the rotational compliance provided by compliant structure and mechanism C may be selected based on access constraints that lead to an off-axis approach to the fastener component or based on a coordination strategy in which the holding subsystem seats while the driving subsystem applies an axial load.

In some embodiments, bolt-holding tip assembly A is disposed at a distal end of adjustable extension structure B and defines a tool-side fastener engagement interface that engages a bolt head, nut, or other fastener component for stabilization during a fastening operation. Interchangeable screw driver tips A1 are configured to be selectively installed at bolt-holding tip assembly A to match different fastener geometries and sizes, including by exchanging one of interchangeable screw driver tips A1 for another during tool changeover or task reconfiguration. Additionally, bolt-holding tip assembly A may include an interface configured to transmit torque between adjustable extension structure B and the installed one of interchangeable screw driver tips A1, and the interface may include a keyed coupling, a splined coupling, or a socket-like coupling. Furthermore, bolt-holding tip assembly A transfers reaction torque and restraint loads into adjustable extension structure B when the engaged first fastener component is held against rotation while a corresponding second fastener component is driven on the opposite side of a fastening surface.

In some embodiments, adjustable extension structure B provides reach for accessing fastener components located in restricted or obstructed spaces and provides a torque path between bolt-holding tip assembly A and connection interface D. Adjustable extension structure B may include a rigid body, bracket features, and coupling features that position bolt-holding tip assembly A at a selected standoff from connection interface D. Additionally, adjustable extension structure B may be configured with a selectable length and structural configuration to tune leverage and packaging for a given fastening environment. Furthermore, during a dual-side fastening operation, adjustable extension structure B functions as a lever arm that transfers reaction torque generated at bolt-holding tip assembly A toward the robot-side mounting portion, enabling a robotic manipulator coupled at connection interface D to manage reaction loading while the corresponding fastener component is tightened by a separate driving subsystem. In some embodiments, adjustable extension structure B includes one or more structural ribs, gussets, or section-modulus features configured to support torsional loading transmitted between bolt-holding tip assembly A and compliant structure and mechanism C.

According to an embodiment, power motor B1 is coupled to adjustable extension structure B and is configured to selectively induce rotational motion at bolt-holding tip assembly A or to provide controllable torque reaction management during fastening-related tasks. Additionally, power motor B1 may be electrically powered and operable under speed control, torque control, and/or angular position control, including responsive to encoder feedback, motor current sensing, and/or externally provided sensor feedback. Furthermore, power motor B1 may be controlled to apply a selected counter-torque to manage relative rotation between fastener components during tightening, and power motor B1 may be controlled to apply a loosening torque during removal operations. Furthermore, in a holding mode, power motor B1 may remain inactive while bolt-holding tip assembly A restrains rotation via mechanical engagement with the first fastener component, or power motor B1 may be commanded to apply a counter-torque or controlled rotation to the engaged first fastener component in coordination with a driving subsystem operating on the opposite side of the fastening surface.

In one aspect, compliant structure and mechanism C is disposed between adjustable extension structure B and connection interface D and is configured to accommodate angular misalignment between the bolt-holding tool and the engaged fastener component while maintaining a torque-transfer path for restraint and/or actuation. In the configuration illustrated in FIG. 3, compliant structure and mechanism C provides rotational compliance about a pivot axis defined within the compliant structure and mechanism C, enabling relative angular displacement between the tool-side portion and the robot-side portion when contact forces and/or positional variation occur during seating of interchangeable screw driver tips A1 on the fastener component. Additionally, compliant structure and mechanism C includes linear sliding rails C1 and spring C2, wherein linear sliding rails C1 define a guided motion path that constrains relative motion to a selected rotational degree of freedom, and spring C2 biases the compliant structure toward a nominal angular position. Furthermore, the rotational compliance of compliant structure and mechanism C supports engagement of bolt-holding tip assembly A with reduced impact loading and accommodates alignment variation while allowing adjustable extension structure B to transmit holding loads and reaction torque through compliant structure and mechanism C during a fastening operation. In some embodiments, compliant structure and mechanism C is implemented as a hinge assembly with one or more bearing elements, and spring C2 is coupled across the hinge assembly to provide a restoring torque. Additionally, compliant structure and mechanism C may include a travel limiter configured to set an angular range of motion and to limit relative rotation between the robot-side portion and the tool-side portion during engagement.

In some embodiments, linear sliding rails C1 and spring C2 cooperate to set a compliance value and a compliance range for the rotational compliance behavior. Linear sliding rails C1 may be configured as guided members that couple a rotating portion and a fixed portion of compliant structure and mechanism C such that relative motion occurs along a guided arc or guided translation that maps to rotation about the pivot axis. Additionally, spring C2 may be selected or adjusted to tune bias torque opposing angular displacement, including by selecting a spring rate and a preload setting, and the allowable travel of linear sliding rails C1 may set a limit on angular deflection. Furthermore, compliant structure and mechanism C may be configured to be rigid along one or more directions transverse to the rotational compliance degree of freedom, supporting controlled holding torque transfer between bolt-holding tip assembly A and connection interface D while the compliant response assists alignment during engagement and during coordinated dual-side tightening. In some embodiments, the rotational compliance is supplemented with an axial compliance element disposed in series with compliant structure and mechanism C, and the axial compliance element is configured to regulate axial engagement force while the rotational compliance regulates alignment about the pivot axis.

According to an embodiment, connection interface D provides a robot-side coupling for mounting the bolt-holding subsystem to a robotic manipulator, including a mobile robotic arm, a fixed-base robotic arm, or a tool changer interface. Mounting interface plate D1 forms a structural attachment feature of connection interface D and is configured to couple to an end-of-arm interface via a bolt pattern, adapter plate, or mating tool mount. Additionally, connection interface D may include a structural housing that supports compliant structure and mechanism C and that defines an interface geometry for repeatable mounting orientation relative to the robotic manipulator. Furthermore, connection interface D is arranged to receive operational loads transmitted through compliant structure and mechanism C, including axial contact forces arising during seating of bolt-holding tip assembly A and reaction forces associated with torque applied to, or resisted by, the engaged fastener component. Furthermore, the arrangement of connection interface D, compliant structure and mechanism C, adjustable extension structure B, power motor B1, and bolt-holding tip assembly A supports an operational sequence in which a robotic manipulator positions bolt-holding tip assembly A toward a target fastener component, compliant structure and mechanism C accommodates angular misalignment during engagement, and adjustable extension structure B provides a torque-reaction path while the fastener component is restrained or rotated in coordination with a driving subsystem on an opposite side of a fastening surface. In some embodiments, connection interface D is configured to couple to a tool changer that provides electrical power and data connectivity to power motor B1, and the tool changer is configured to support interchange of the bolt-holding subsystem relative to the robotic manipulator.

Modifications, additions, or omissions may be made to the subsystems of FIG. 3 without departing from the scope of the present disclosure. For example, in some embodiments, the subsystems may include any number of other components that may not be explicitly illustrated or described.

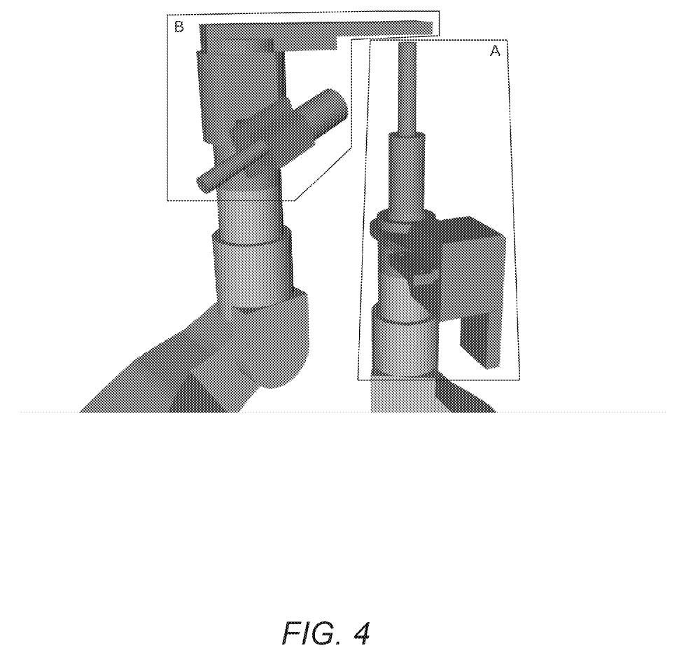

FIG. 4 is a perspective view illustrating an example robotic embodiment in which a driving tool A and a holding tool B are mounted to respective robotic arms for performing a dual-side fastening operation across a fastening surface, in accordance with at least one embodiment of the present disclosure. In this configuration, tool A corresponds to a screw-driving subsystem as described with respect to FIG. 1, and tool B corresponds to a holding subsystem as described with respect to FIGS. 2 and 3. Tool A is positioned on a first side of the fastening surface to engage a first fastener component for driven rotation, and tool B is positioned on an opposite side of the fastening surface to engage and stabilize a corresponding fastener component, such that controlled torque applied by tool A is coupled into the fastener pair while tool B manages reaction torque and restraint loading. Additionally, tool A and tool B may be mounted to separate robotic manipulators, or one or both of tool A and tool B may be mounted to a common robotic platform that provides coordinated motion on both sides of the fastening surface.

In one aspect, tool A is mounted at an end-of-arm interface of a robotic manipulator and includes a motor-driven fastener engagement interface configured to apply rotational motion and torque to a fastener component during tightening or loosening. Tool A is moved by the robotic manipulator through an approach trajectory toward the fastener engagement location and is aligned with the fastener engagement axis using one or more feedback modalities, including visual feedback, force feedback, tactile feedback, and proprioceptive feedback from the robotic manipulator and/or the tool. Additionally, during seating of the fastener engagement interface, tool A accommodates residual positional variation by controlled compliance provided within the screw-driving subsystem, including axial compliance along the engagement direction and/or angular compliance depending on the implemented compliance portion, while maintaining a torque transmission path between a power motor and the fastener engagement interface. Furthermore, tool A may be controlled according to a tightening profile selected from torque control, angle control, or torque-angle control based on a target joint specification, and tool A may be controlled to stop rotation in response to detection of a torque threshold, an angle threshold, or a state transition indicative of fastener seating.

According to an embodiment, tool B is mounted at an end-of-arm interface of a second robotic manipulator and includes a holding fastener engagement interface configured to engage a bolt head, nut, or other fastener component positioned on the opposite side of the fastening surface. Tool B is moved into a holding position in coordination with tool A so that the holding fastener engagement interface seats on the corresponding fastener component while the driving operation is performed by tool A. Additionally, tool B includes a compliance portion that regulates engagement forces during seating while enabling transfer of reaction torque away from the fastener component and into the robotic manipulator through a robot-side coupling. Furthermore, tool B may include an extension structure that provides reach into confined or obstructed spaces and that functions as a lever arm to transmit reaction loading to the robotic arm during dual-side fastening. In some embodiments, tool B is configured to operate in a passive restraint mode, and in other embodiments tool B is configured to apply controlled counter-torque or controlled rotation to the corresponding fastener component to manage relative rotation between the fastener components.

In some embodiments, FIG. 4 represents an operational sequence in which tool A and tool B operate cooperatively in a synchronized manner for dual-side fastening. Tool A approaches and aligns with the driven fastener component, engages the driven fastener component with reduced impact loading due to compliance, and applies controlled rotational motion from a power motor through an extension and tip assembly to tighten or loosen the driven fastener component. Additionally, tool B approaches and aligns with the corresponding fastener component, engages the corresponding fastener component with regulated force through a compliance mechanism, and restrains rotation of the corresponding fastener component while reaction torque generated by tool A is transferred through tool B and into the robotic arm. Furthermore, after completion of the fastening operation, tool A and tool B are each actuated to perform a force release motion in which the respective tool retracts by a selected displacement to reduce contact force, decouple the fastener engagement interfaces from the fastener components, and allow subsequent repositioning for a next fastening cycle. Furthermore, the force release motion may be implemented as a commanded retraction of a robotic manipulator, as a commanded change in a compliance setpoint, or as a commanded change in motor torque applied by tool A or tool B.

In one aspect, the cooperative arrangement depicted in FIG. 4 supports alternative operating modes in which one or both tools contribute rotational actuation, depending on a selected fastening strategy and access constraints. Tool A may operate under speed control, torque control, and/or angular position control to deliver a specified tightening torque, tightening angle, or combined torque-angle profile, and tool B may remain passive while providing mechanical restraint, or may be commanded to apply counter-torque or controlled rotation to manage joint preload and reaction forces. Additionally, the compliance mechanisms within tool A and/or tool B enable accommodation of misalignment between the fastener components during engagement, including where the robotic arms exhibit positioning error, where the fastening surface is irregular, or where access geometry limits approach angles, while constraining motion along non-compliant axes to support controlled application of torque during the dual-side fastening operation. Furthermore, one or both of tool A and tool B may be operated under an impedance control mode or an admittance control mode implemented by a controller of the robotic system, and the controller may use sensor feedback to regulate contact force while maintaining relative alignment between the tools and the fastener components.

According to an embodiment, FIG. 4 also illustrates that the driving and holding subsystems may be implemented on separate robotic manipulators to distribute load handling and to enable coordinated motion planning for dual-side access. In this arrangement, each robotic arm positions its respective tool relative to the fastening surface while compliance within the tool accommodates residual error during final seating. Additionally, one or more sensors may be integrated with tool A, tool B, one or both robotic arms, or a surrounding perception system to provide feedback including force, torque, position, velocity, and visual information for closed-loop control during alignment, engagement, tightening, and disengagement. Furthermore, sensor data may be used by a robotic controller to coordinate the cooperative behavior of tool A and tool B, including timing of engagement, regulation of contact force through compliance, and control of rotational torque delivery to secure the fastener components together. In some embodiments, the robotic controller estimates tightening state based on motor current, motor speed, and commanded torque, and in other embodiments the robotic controller uses a force/torque sensor disposed at a wrist interface to determine contact conditions during engagement and to update motion commands for tool A and tool B.

Modifications, additions, or omissions may be made to the subsystems of FIG. 4 without departing from the scope of the present disclosure. For example, in some embodiments, the subsystems may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to embodiments containing only one such recitation, even when the same claim includes the introductory phrases "one or more" or "at least one" and indefinite articles such as "a" or "an" (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of "two recitations," without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A compliant fastening subsystem for use with a robotic manipulator, comprising:
a fastener engagement interface configured to engage a screw, nut, or bolt;
a power transmission element configured to provide rotational motion to the fastener engagement interface; and
a compliance mechanism operatively coupled between the power transmission element and the robotic manipulator,
wherein the compliance mechanism provides controlled compliance along a selected axis while remaining substantially rigid along one or more other axes to enable controlled application of torque to the fastener engagement interface.

2. The compliant fastening subsystem of claim 1, wherein the compliance mechanism comprises a mechanical compliance element selected from a spring, flexure, elastomer, damper, or a combination thereof.

3. The compliant fastening subsystem of claim 1, wherein compliance is provided mechanically, actively through control software, or by a combination of mechanical and active control.

4. The compliant fastening subsystem of claim 1, wherein the compliance mechanism comprises a spring-loaded slider including linear sliding rails defining a guided translation path along the selected axis and a spring biasing relative motion along the guided translation path.

5. The compliant fastening subsystem of claim 4, wherein a compliance value is adjustable by modifying at least one of a spring stiffness, a preload setting, or an allowable travel length of the spring-loaded slider.

7. The compliant fastening subsystem of claim 1, wherein the compliance mechanism is configured to provide rotational compliance about a pivot axis.

8. The compliant fastening subsystem of claim 7, wherein the compliance mechanism comprises a hinge assembly with one or more bearing elements and a spring coupled across the hinge assembly to provide a restoring torque.

9. The compliant fastening subsystem of claim 1, wherein the compliance mechanism is positioned between the power transmission element and a connection interface configured to couple to the robotic manipulator.

10. The compliant fastening subsystem of claim 1, wherein the compliance mechanism is positioned between a motor of the power transmission element and the fastener engagement interface.

11. The compliant fastening subsystem of claim 1, wherein the fastener engagement interface comprises an interchangeable tip configured to be selectively installed to match different fastener drive geometries and sizes.

12. The compliant fastening subsystem of claim 7, wherein the fastener engagement interface includes a retention feature configured to retain the interchangeable tip against axial separation during torque application.

13. The compliant fastening subsystem of claim 1, wherein the power transmission element comprises an electrically powered motor and an adjustable extension configured to transmit rotational motion from the motor to the fastener engagement interface, the adjustable extension having an adjustable length to position the fastener engagement interface at a selected offset from the motor.

14. The compliant fastening subsystem of claim 1, wherein the power transmission element comprises a motor controlled based on feedback from at least one of a current sensor, a torque sensor, a force sensor, or a vision system.

15. The compliant fastening subsystem of claim 1, further comprising one or more sensors configured to provide feedback indicative of at least one of angular position, angular velocity, contact force, or engagement state.

16. The compliant fastening subsystem of claim 1, wherein the compliant fastening subsystem is configured to operate under at least one of torque control, speed control, angular position control, or a combined torque-angle profile.

17. The compliant fastening subsystem of claim 1, further comprising a connection interface including a mounting interface plate configured for coupling to an end-of-arm interface of the robotic manipulator.
